(19) United States
(12) Patent Application Publication
(10) Pub. No.: US 2005/0208267 A1
(43) Pub. Date: Sep. 22, 2005

(54) Ornamentation device

(76) Inventor: Laurie A. Mazzotta, Baltimore, MD (US)

Correspondence Address: WHITEFORD, TAYLOR & PRESTON, LLP;ATTN: GREGORY M STONE, SEVEN SAINT PAUL STREET, BALTIMORE, MD, 21202-1626, US

(21) Appl. No.: 11/042,549

(22) Filed: Jan. 25, 2005

Related U.S. Application Data
(60) Provisional application No. 60/540,403, filed on Jan. 29, 2004.

(51) Int. Cl. B32B 3/10

(52) U.S. Cl. 428/137

(57) ABSTRACT

A clothing ornamentation device and method for decorating an individual wearing a garment. The device includes a body having a centrally located oval-shaped channel and a clasp that allows the ornament to be attached to a variety of strands. The device can be attached to lingerie, belt loops, bikini straps, dress straps, and the like. The device may be constructed of an appropriate material such as a base metal or precious metal, and may display precious or semi-precious gemstones, as well as crystals, beads and other items of color. The device allows variation of number and composition of the ornaments.

### CROSS REFERENCE TO RELATED APPLICATION

This application is based upon and claims benefit of co-pending U.S. Provisional Patent Application Ser. No. 60/540,403 entitled “Ornamentation Device”, filed with the U.S. Patent and Trademark Office on Jan. 30, 2004 by the inventor herein, the specification of which is incorporated herein by reference.

### BACKGROUND OF THE INVENTION

1. Field of the Invention

This invention generally relates to a method and a device for adding decoration to clothing, and more particularly, but not by way of limitation, to a decorative device for attaching to straps, loops, or ribbons, in order to add a splash of color and bring attention to the area of the decorated part of the wearer.

2. Background of the Prior Art

Historically, people have enjoyed placing ornamentation around the neck and chest area. Most of the known ornaments have encompassed embodiments such as necklaces, ties, and bolo ties, which surround the neck and thus draw attention to the wearer's head and face. An example of such a device is taught in U.S. Pat. No. 4,143,422 to Wilson, which teaches the use of an ornamental member together with a clasp that reaches over the seam of the wearer's collar. The Wilson device is particularly useful for draping a string of beads down along the front of the wearer's shirt.

Yet another approach to decorating the upper torso area of a wearer is taught in U.S. Pat. No. 4,718,252 to Fossas. The Fossas device provides a wearer with an ornamental necklace that incorporates a balancing means for keeping the necklace properly centered over the wearer's shoulder's.

U.S. Pat. No. 6,279,171 to Brancato discloses ornamental jewelry supports for garments such as bras, bikini tops, halters, strapless dresses and the like. The supports are adjustable and can be worn in combinations to enhance the appearance.

U.S. Pat. No. 5,682,648 to Miller describes a mechanism for holding ornaments onto clothing using magnetic attraction. The magnet enables the holder to secure the ornament without having to damage the clothing by either piercing, such as with a needle, or pinching, such as with a clasp.

It is known that it is advantageous to decorate a person's neck and shoulder area. However, most of the known devices for decorating a person's neck and shoulder area include some sort of means for ensuring that the ornament is wrapped completely around the wearer's neck. In addition, it is known that another way to decorate the upper torso area, in order to draw attention to the wearer's head and face area, is by wearing earrings with ornamentation. Still another method of drawing attention to the upper torso, and particularly the head and face, is the use of necklaces, pins, or the use of beads and the like in the wearer's hair. Still yet, another manner for drawing attention to the wearer's head and face is to weave into the person's hair a braided hair extension that incorporates beads and the like.

Thus, with a variety of different ornaments and devices, a person may draw attention to themselves, and particularly to the person's head and face.

There remains a need, however, for a simple device that can achieve the effect of several items of jewelry and ornamentation in order to draw attention to the wearer, but that is not limited to decoration for the wearer's head and face area.

Moreover, there remains a need for an ornament device that can be worn on any strap or loop and is comfortable, secure, and unobtrusive to the wearer.

Accordingly, there remains a need for an ornamentation device that allows the wearer to decorate their clothing, while allowing the ability to decorate accessories, as well.

### SUMMARY OF THE INVENTION

It is, therefore, an object of the present invention to provide a simple ornamentation device that avoids the disadvantages of the prior art.

It is another object of the present invention to provide an ornamentation device that can be worn on a variety of clothing. A related object is to provide an ornamentation device that can be used to decorate accessories.

Another object of the present invention is to provide a piece of jewelry that adds a splash of color to a wearer's appearance. A related object of the present invention is to provide a piece of jewelry that can be attached to a strap or other thin strands for decoration.

In accordance with the above objects, an ornamentation device for decorating an article of clothing is disclosed. The device can be attached to a strap of a bikini, dress, or lingerie, attached to a belt loop, or attached to a ribbon and woven into the wearer's hair. The device may be constructed of an appropriate material such as a base metal or precious metal, and may display precious or semi-precious gemstones, as well as crystals, beads, and other items of color. The device may be generally oval shaped with a centrally located narrow channel and a clasp on a lower portion of the device that enables attachment to straps, loops, thin strands, and the like.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 is a perspective view of an ornamentation device according to a first embodiment of the present invention.

FIG. 2 is an elevational view of the device of FIG. 1.

FIG. 3 is a perspective view of an ornamentation device for describing additional features of the present invention.

### DETAILED DESCRIPTION OF THE INVENTION

The invention summarized above and defined by the enumerated claims may be better understood by referring to the following description, which should be read in conjunction with the accompanying drawings in which like reference numbers are used for like parts. This description of an embodiment, set out below to enable one to practice an implementation of the invention, is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent methods and systems do not depart from the spirit and scope of the invention in its broadest form.

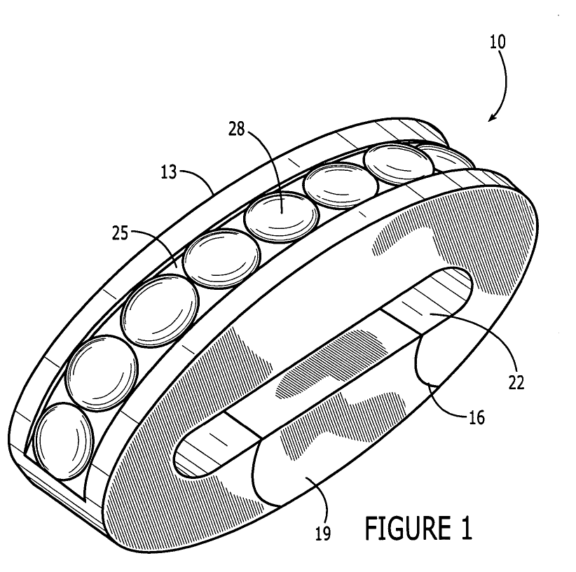

FIG. 1 shows a view of an ornamentation device, indicated generally as 10. Device 10 comprises an upper section 13, a lower section 16 containing a clasp 19, and a centrally located channel 22. In a preferred embodiment, device 10 is generally oval shaped; the dimension of the overall length of which is approximately twice the dimension of the height of said device 10. Other appropriate shapes, such as circular or rectangular can also be used. The width of device 10 can vary as desired. Channel 22 is substantially oval shaped and of sufficient height and width to enable the device 10 to be attached to a strand, such as a strap on an article of clothing.

The upper section 13 comprises a surface 25 displaying a decorative embossment and/or a plurality of decorative elements 28, such as stones, beads, crystals, colored glass, sequins, and the like. According to one feature of a preferred embodiment of the instant invention, device 10 may be constructed of precious, semi-precious, or non-precious material of metal, plastic or other appropriate substance. Such decorative embossment may comprise a discernable color, as shown in FIG. 3, or, in an alternate embodiment, may comprise etching of a design or letters, or the like. Such decorative elements 28 may comprise precious, semi-precious, or non-precious gemstones, or the like.

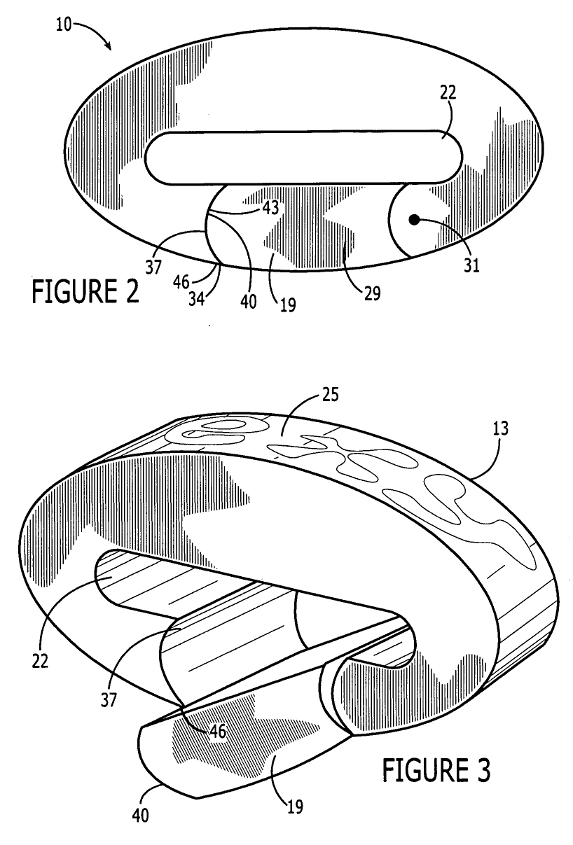

Referring to FIGS. 2 and 3, the lower section 16 comprises pivotable clasp 19 having an arm 29 with a hinge 31 on a first end and a close-fitting closure mechanism 34 on a second end. In one embodiment of the present invention, such closure mechanism 34 comprises a concave arcuate portion 37 of said lower section 16 that mates with a convex arcuate portion 40 of said arm 29. The radius of said concave arcuate portion 37 is substantially equal to the radius of said convex arcuate portion 40 and said radius is smaller than the pivoting radius of said arm 29 about said hinge 31, such that arm 29 is held in a closed position with convex arcuate portion 40 fitting within concave arcuate portion 37. Arm 29 pivots about hinge 31. Only a small amount of force is required to move the distal end 43 of arm 29 over the lower projection 46 of said convex arcuate portion, in order to displace arm 29 from the closed position.

In a preferred embodiment, closure mechanism 34 is designed to enable arm 29 to open only in a direction away from channel 22. The concave arcuate portion 37 and convex arcuate portion 40 do not permit arm 29 to pivot past the closed position, into channel 22.

For purposes of example and not to limit its use in any way, device 10 can be attached to items such as belt loops, bra straps, straps for a bikini top or bottom, lingerie straps, and spaghetti straps for dresses, shoelaces, etc. In addition to articles of clothing, device 10 can be attached to bracelets, necklaces, and straps for handbags.

In use, device 10 can be attached to an appropriate article by opening said clasp 19 and sliding said device 10 into the desired position. Then clasp 19 is closed. Several devices may be stacked for added color or visual enhancement. In an alternate embodiment, the device may be attached to a ribbon for attachment in the wearer's hair or as a dangling strand.

The invention has been described with references to a preferred embodiment. While specific values, relationships, materials and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with such underlying concept. It is intended to include all such modifications, alternatives and other embodiments insofar as they come within the scope of the appended claims or equivalents thereof. It should be understood, therefore, that the invention may be practiced otherwise than as specifically set forth herein. Consequently, the present embodiments are to be considered in all respects as illustrative and not restrictive.

1. An ornamentation device, comprising:
a body having
a top portion;
a bottom portion containing a clasp; and
an oval-shaped channel between said top portion and said bottom portion
wherein the oval-shaped channel is sized and configured to enable the device to be attached to a strand.

2. The ornamentation device according to claim 1, wherein said top portion is connected to said bottom portion such that said channel is substantially surrounded by said top portion and said bottom portion.

3. The ornamentation device according to claim 1, wherein said body is generally oval-shaped.

4. The ornamentation device according to claim 3, wherein the length of said body is approximately twice the dimension of the height of said body.

5. The ornamentation device according to claim 1, said top portion further comprising a surface displaying a decoration.

6. The ornamentation device according to claim 5, wherein said decoration is selected from the group consisting of:
an embossment;
a label; and
an engraving.

7. The ornamentation device according to claim 6, said decoration further comprising a discernable color.

8. The ornamentation device according to claim 5, wherein said decoration further comprises a decorative element.

9. The ornamentation device according to claim 8, wherein said decorative element is selected from the group consisting of:
precious gemstones;
semi-precious gemstones;
non-precious stones;
crystals;
beads;
glass; and
combinations of the above.

10. The ornamentation device according to claim 1, wherein said clasp is selectively moveable between an open position and a closed position.

11. The ornamentation device according to claim 1, said clasp further comprising:
an arm having a first end and a second end wherein
said arm is pivotably connected at said first end to a first part of said bottom portion by a hinge; and
said arm is held at said second end to a second part of said bottom portion by a close-fitting closure mechanism.

12. The ornamentation device according to claim 11, said close-fitting closure mechanism further comprising:
a convex arcuate section on the second end of said arm and a concave arcuate section on the second part of said bottom portion of said body.

13. The ornamentation device according to claim 12, wherein the radius of said convex arcuate section is substantially equal to the radius of said concave arcuate section.

14. The ornamentation device according to claim 12, wherein the radius of said convex arcuate section is smaller than the pivoting radius of said arm about said hinge.

15. The ornamentation device according to claim 12, wherein said arm is held in a closed position with said concave arcuate section fitting within said convex arcuate section.

16. The ornamentation device according to claim 12, wherein only a small amount of force is required to displace said arm from said closed position to said open position.

17. The ornamentation device according to claim 1, wherein said strand is selected from the group consisting of:
belt loops;
bra straps;
bikini top straps or bottom straps;
lingerie straps;
dress straps;
shoelaces;
ribbons;
bracelets;
necklaces; and
handbag straps.

18. The ornamentation device according to claim 1, wherein said body is constructed of material selected from the group consisting of:
precious metal;
semi-precious metal;
non-precious metal;
plastic; and
combinations of the above.
